(19) United States
(12) Patent Application Publication
(10) Pub. No.: US 2026/0323307 A1
(43) Pub. Date: Oct. 15, 2026

(54) APPARATUS AND METHOD FOR MANAGING A COMMUNICATION COVERAGE FOR DETECTING AND MANAGING BLIND AREA

(71) Applicants: HYUNDAI MOTOR COMPANY, Seoul (KR); Kia Corporation, Seoul (KR); SUNGSHIN WOMEN’S UNIVERSITY R&DB FOUNDATION, Seoul (KR)

(72) Inventors: Soomin SHIM, Gyeonggi-do (KR); Jaehoon YOU, Gyeonggi-do (KR); Won Hee KIM, Gyeonggi-do (KR); Seong Wook HWANG, Seoul (KR); Joon Young KIM, Seoul (KR); Namgyo KIM, Gangwon-do (KR); Young Eun KIM, Gyeonggi-do (KR); Bo Kyung KIM, Daejeon (KR); Gyeongbin RYOO, Seoul (KR); Jeong Min OH, Seoul (KR); Ji Soo KANG, Seoul (KR)

(21) Appl. No.: 19/400,142

(22) Filed: Nov. 25, 2025

(30) Foreign Application Priority Data
Apr. 10, 2025 (KR) 10-2025-0046560

(51) Int. Cl. H04W 16/18; H04B 17/318

(52) U.S. Cl. CPC H04W 16/18; H04B 17/318

(57) ABSTRACT

An apparatus for managing a communication coverage can include a transceiver, a memory, and a processor in communication with the memory, the processor configured to receive location and coverage radius information of a router, generate a first coverage map corresponding to the location of the router based on the location and coverage radius information of the router, request a first location representing a location of the first robot and a first RSSI that is a communication signal strength corresponding to the first location to a first robot, receive the first location and the first RSSI from the first robot, determine whether the first RSSI is a reliable value, and determine whether the first location is included in a connection area of the first coverage map based on the first coverage map, the first location, and the first RSSI, when the first RSSI is a reliable value.

### CROSS-REFERENCE TO RELATED APPLICATION

This application claims priority to and the benefit of Korean Patent Application No. 10-2025-0046560 filed with the Korean Intellectual Property Office on Apr. 10, 2025, the entire contents of which is incorporated herein by reference.

### BACKGROUND

Due to the recent increase in the use of indoor wireless communication services and the demand for improved speed, accurately identifying the communication coverage area within a building and managing the service area are major challenges. However, due to the complexity of the indoor environment, such as building structures and specific situations, due to the nature of indoor wireless communications, it is difficult to create an accurate coverage map, and accordingly, there are concerns that service interruption and quality deterioration can occur when indoor communication users enter a communication blind area.

### SUMMARY

The present disclosure relates to an apparatus and method for managing a communication coverage by detecting a blind area by using a communication signal strength detected by a plurality of robots, and by controlling a transmission power of a router to be raised as much as an adjustment value capable of removing a blind area.

Aspects of the present disclosure provide an apparatus and method for managing a communication coverage area, that determines whether a particular location corresponds to a blind area by using an RSSI measured by a plurality of robots receiving actual communication signals, and controls a router by calculating a router power adjustment value required to belong to a communication connection area, when it corresponds to the blind area.

The technical objective to be achieved by the present disclosure is not limited to the task for solving the above-mentioned problems, and another task that is not mentioned will be clearly understood by one of ordinary skill in the art through the description below.

In some implementations, aspects of the present disclosure provide an apparatus for managing a communication coverage. The apparatus comprises: a transceiver; a memory; and one or more processors in communication with the memory, wherein the one or more processors are configured to: receive location and coverage radius information of a router, through the transceiver; generate a first coverage map corresponding to the location of the router based on the location and coverage radius information of the router; request a first location representing a location of the first robot and a first Received Signal Strength Indicator (RSSI) that is a first communication signal strength corresponding to the first location of the first robot, wherein the first robot is configured to measure a communication signal strength; receive the first location and the first RSSI from the first robot, through the transceiver; determine whether the first RSSI is a reliable value; determine whether the first location is included within a connection area of the first coverage map based on the first coverage map, the first location, and the first RSSI, based on the first RSSI being a reliable value; set the first location as a blind area based on a determination that the first location is not included in the connection area; calculate a first adjustment value based on a difference between the first RSSI and a first threshold value for a second communication signal strength required for the first location to be within the connection area; and transmit a control request to adjust a transmission power as much as the first adjustment value to the router, through the transceiver.

The connection area is a region between the location of the router and a location where a communication signal strength transmitted by the router is measured to be the first threshold value.

The one or more processors are configured to: determine whether the first RSSI is within a signal strength range corresponding to the first location of the first coverage map; transmit a measurement request for an RSSI of the first location to the first robot and a second robot, through the transceiver, based on a determination that the first RSSI is not within the signal strength range; receive a second RSSI that is an RSSI value of the first location measured by the first robot and a third RSSI that is an RSSI value of the first location measured by the second robot, through the transceiver; and determine the first RSSI as a reliable value based on a determination that (i) a first absolute value obtained by subtracting the second RSSI from the first RSSI is equal to or lower than a first value and (ii) a second absolute value obtained by subtracting the third RSSI from the first RSSI is equal to or lower than a first value.

The one or more processors are configured to: determine which region among a plurality of regions included in the connection area of the first coverage map the first location corresponds to; and determine whether the first RSSI is included in the signal strength range corresponding to a first region to which the first location belongs.

The one or more processors are configured to: modify the first coverage map by using drawing data comprising a plurality of location coordinates representing locations of the first coverage map and structure data existing at one or more first coordinates among the plurality of location coordinates; modify the first coverage map by setting the first location as the blind area, based on receiving abnormal situation information of the first location from the first robot or a second robot, through the transceiver; and set the first location as the blind area based on a determination that the first RSSI is not included in a signal strength range corresponding to the first location of the modified first coverage map.

The one or more processors are configured to modify the connection area to be a region between the one or more first coordinates of the structure data and the location of the router based on a determination that one or more first coordinates of the structure data are within the connection area.

The one or more processors are configured to: store the first location in the memory based on the first RSSI not being a reliable value; and transmit a command for re-measuring an RSSI of the first location after a first preset time to the first robot and a second robot.

The one or more processors are configured to: receive modified coverage radius information from the router, through the transceiver; and generate a second coverage map corresponding to the location of the router based on the location of the router and the modified coverage radius information.

In some implementations, aspects of the present disclosure provide a method for managing a communication coverage. The method comprises: receiving location and coverage radius information of a router, through a transceiver; generating a first coverage map corresponding to the location of the router based on the location of the router and the coverage radius information; requesting a first location representing a location of the first robot and a first Received Signal Strength Indicator (RSSI) that is a first communication signal strength corresponding to the first location of the first robot, wherein the first robot is configured to measure a communication signal strength; receiving the first location and the first RSSI from the first robot, through the transceiver; determining whether the first RSSI is a reliable value; determining whether the first location is included within a connection area of the first coverage map based on the first coverage map, the first location, and the first RSSI based on the first RSSI being a reliable value; setting the first location as a blind area based on a determination that the first location is not included in the connection area; calculating a first adjustment value based on a difference between the first RSSI a first threshold value for a second communication signal strength required for the first location to be within the connection area; and transmitting a control request to adjust a transmission power as much as the first adjustment value to the router, through the transceiver.

The connection area is a region between the location of the router and a location where a communication signal strength transmitted by the router is measured to be the first threshold value.

The determining whether the first RSSI is a reliable value comprises: determining whether the first RSSI is within a signal strength range corresponding to the first location of the first coverage map; transmitting a measurement request for an RSSI of the first location to the first robot and the second robot, through the transceiver based on a determination that the first RSSI is not within the signal strength range; receiving a second RSSI that is an RSSI value of the first location measured by the first robot and a third RSSI that is an RSSI value of the first location measured by the second robot, through the transceiver; and determining the first RSSI as a reliable value based on a determination that (i) a first absolute value obtained by subtracting the second RSSI from the first RSSI is equal to or lower than a first value and (ii) a second absolute value obtained by subtracting the third RSSI from the first RSSI is equal to or lower than a first value.

The determining whether the first RSSI is within the signal strength range corresponding to the first location of the first coverage map comprises: determining which region among a plurality of regions included in the connection area of the first coverage map the first location corresponds to; and determining whether the first RSSI is included in the signal strength range corresponding to a first region to which the first location belongs.

The determining whether the first location is included in the connection area of the first coverage map comprises: modifying the first coverage map by using drawing data comprising a plurality of location coordinates representing locations of the first coverage map and structure data existing at one or more first coordinates among the plurality of location coordinates; modifying the first coverage map based on receiving abnormal situation information of the first location from the first robot or a second robot, through the transceiver; and setting the first location as the blind area based on a determination that the first RSSI is not included in a signal strength range corresponding to the first location of the modified first coverage map.

The modifying the first coverage map by using the drawing data comprising the wall data comprises: modifying the connection area to be region between the one or more first coordinates of the structure data and the location of the router based on a determination that one or more first coordinates of the structure data are within the connection area.

The method further comprises: storing the first location in a memory based on the first RSSI not being a reliable value; and transmitting a command for re-measuring an RSSI of the first location after a first preset time to the first robot and a second robot.

The method further comprises: receiving modified coverage radius information from the router, through the transceiver; and generating a second coverage map corresponding to the location of the router based on the location of the router and the modified coverage radius information.

In some implementations, aspects of the present disclosure provided a non-transitory computer-readable medium storing one or more instructions for managing a communication coverage. The one or more instructions, when executed by one or more processors, cause the one or more processors to perform operations comprising: receiving location and coverage radius information of a router; generating a first coverage map corresponding to the location of the router based on the location and coverage radius information of the router; requesting a first location representing a location of the first robot and a first Received Signal Strength Indicator (RSSI) that is a first communication signal strength corresponding to the first location of the first robot, wherein the first robot is configured to measure a communication signal strength; receiving the first location and the first RSSI from the first robot; determining whether the first RSSI is a reliable value; determining whether the first location is included within a connection area of the first coverage map based on the first coverage map, the first location, and the first RSSI, based on the first RSSI being a reliable value; setting the first location as a blind area based on a determination that the first location is not included in the connection area; calculating a first adjustment value based on a difference between the first RSSI and a first threshold value for a second communication signal strength required for the first location to be within the connection area; and transmitting a control request to adjust a transmission power as much as the first adjustment value to the router.

The determining whether the first RSSI is a reliable value comprises: determining whether the first RSSI is within a signal strength range corresponding to the first location of the first coverage map; transmitting a measurement request for an RSSI of the first location to the first robot and the second robot based on a determination that the first RSSI is not within the signal strength range; receiving a second RSSI that is an RSSI value of the first location measured by the first robot and a third RSSI that is an RSSI value of the first location measured by the second robot; and determining the first RSSI as a reliable value based on a determination that (i) a first absolute value obtained by subtracting the second RSSI from the first RSSI is equal to or lower than a first value and (ii) a second absolute value obtained by subtracting the third RSSI from the first RSSI is equal to or lower than a first value.

The determining whether the first RSSI is within the signal strength range corresponding to the first location of the first coverage map comprises: determining which region among a plurality of regions included in the connection area of the first coverage map the first location corresponds to; and determining whether the first RSSI is included in the signal strength range corresponding to a first region to which the first location belongs.

The connection area is a region between the location of the router and a location where a communication signal strength transmitted by the router is measured to be the first threshold value, wherein the determining whether the first location is included in the connection area of the first coverage map comprises: modifying the first coverage map by using drawing data comprising a plurality of location coordinates representing locations of the first coverage map and structure data existing at one or more first coordinates among the plurality of location coordinates; modifying the first coverage map based on receiving abnormal situation information of the first location from the first robot or a second robot; and setting the first location as the blind area based on a determination that the first RSSI is not included in a signal strength range corresponding to the first location of the modified first coverage map.

According to an apparatus and method for managing a communication coverage according to an implementation, a communication blind area can be effectively decreased by monitoring RSSI values actually measured at a particular location from a plurality of robots and adjusting a transmission power of a router, and particularly, even if a structure such as a wall exists in the indoor environment, a more precise communication coverage map can be created, thereby capable of providing a stable communication service environment.

### BRIEF DESCRIPTION OF THE DRAWINGS

FIG. 1 shows an apparatus for managing a communication coverage according to an implementation.

FIG. 2 is a flowchart showing a method for managing a communication coverage according to an implementation.

FIG. 3 is a flowchart showing step S20 among the steps of the method for managing a communication coverage of FIG. 2 in more detail.

FIG. 4 is a flowchart showing step S206 among the steps of the method for managing a communication coverage of FIG. 2 in more detail.

FIG. 5 shows a communication coverage map created based on data received from a plurality of routers according to an implementation.

FIG. 6 illustrates a plurality of detailed signal strength ranges within a region to which a particular location belongs according to an implementation.

FIG. 7 schematically illustrates a method for modifying a coverage map by using drawing data according to an implementation.

FIG. 8 illustrates a process of controlling the router, when an RSSI measured by a system for managing a communication coverage of the present disclosure is a reliable value.

FIG. 9 illustrates a process of preserving and monitoring the measured location, when an RSSI measured by a system for managing a communication coverage of the present disclosure is not a reliable value.

### DETAILED DESCRIPTION

An implementation of the disclosure will be described more fully hereinafter with reference to the accompanying drawings such that a person skill in the art can easily implement the implementation. As those skilled in the art would realize, the described implementations can be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, the terms “unit”, “part” or “portion”, “-er”, and “module” in the specification refer to a unit that processes at least one function or operation, which can be implemented by hardware, software, or a combination of hardware and software.

Hereinafter, implementations of the present disclosure will be described with reference to the drawings.

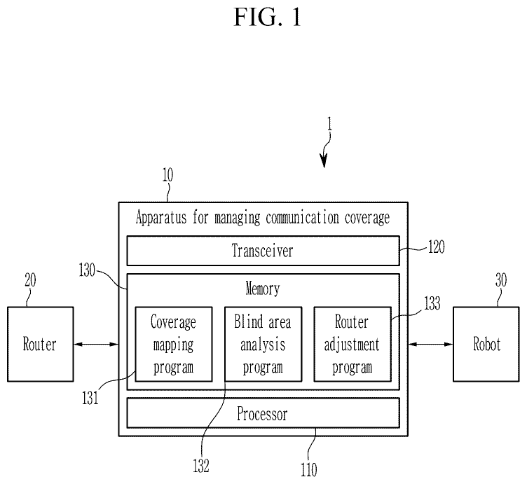

FIG. 1 shows an apparatus for managing a communication coverage according to an implementation.

Referring to FIG. 1, a system 1 for managing a communication coverage can include an apparatus 10 for managing a communication coverage, and a router 20 and a robot 30 outside the apparatus 10 for managing the communication coverage. In the system 1 for managing the communication coverage, the router 20 can transmit communication signals according to a determined signal transmission power, and the robot 30 can receive the communication signals, to measure a Received Signal Strength Indicator (RSSI) representing the reception strength of the communication signals.

The apparatus 10 for managing the communication coverage can include a processor 110, a transceiver 120, and a memory 130. The memory 130 can include a coverage mapping program 131, a blind area analysis program 132 and a router adjustment program 133.

The apparatus 10 for managing the communication coverage can receive coverage radius information representing a location of the router 20 and a communication coverage area from the router 20 by using the transceiver 120. In addition, by executing the coverage mapping program 131 through the processor 110 based on the received coverage radius information, a coverage map surrounding a predetermined radius of the location of the router 20 can be created.

In some implementations, the apparatus 10 for managing the communication coverage can receive a particular location and an RSSI measured at the particular location from the robot 30 (e.g., driving in an indoor/outdoor space) by using the transceiver 120. Based on the received RSSI, the processor 110 can determine whether the received RSSI is a reliable value by executing the blind area analysis program 132, and can determine whether the corresponding location is included in a communication blind area.

In some implementations, when the corresponding location is included in the communication blind area, the processor 110 can calculate a transmission power adjustment value required for the corresponding location to belong to a communication connection area by executing the router adjustment program 133. The processor 110 can transmit the calculated transmission power adjustment value to the router 20 through the transceiver 120, to control the router 20 to raise the transmission power as much as the adjustment value.

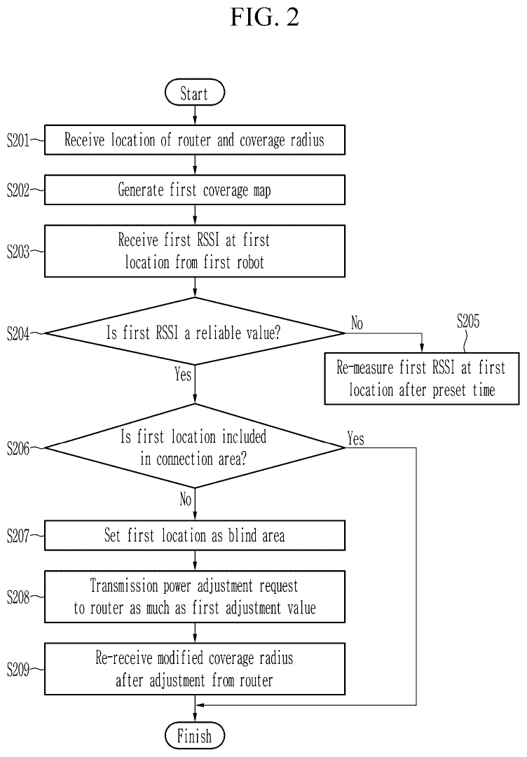

FIG. 2 is a flowchart showing a method for managing a communication coverage according to an implementation.

FIG. 2 illustrates an example process in which the processor 110 can determine a blind area based on signals received from the router 20 and the robot 30, and transmit power adjust signals to the router 20 to stably manage a coverage system in order to remove the blind area.

At step S201, the processor 110 can, through the transceiver 120, receive the location of the router 20 and the coverage radius information representing a communication-available region centered on the location of the router 20 from the router 20 within the system 1 for managing the communication coverage. In an implementation, there can be one or more routers, and the processor 110 can receive the location and the coverage radius information from each router among the one or more routers.

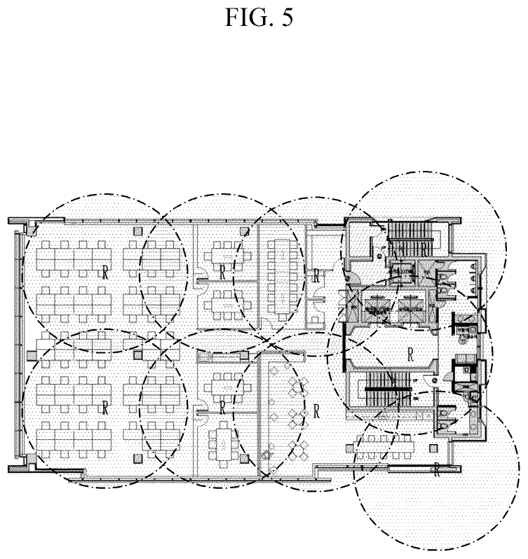

At step S202, the processor 110 can generate a first coverage map indicating a region where the communication signals can be received within a specific coordinate range, based on the location and the coverage radius information of a router received by executing the coverage mapping program 131. As shown in FIG. 5, in some implementations, the location of each of a plurality of routers can be recorded as a (location) coordinate based on location coordinates, for example, included in (indoor/outdoor) drawing data, and the communication connection area can be illustrated/marked in a radius of the corresponding coverage radius information centered on the (location) coordinate of the corresponding router. As shown in FIG. 5, the location of each router can be represented by the symbol ‘R’, and a shaded circle having a distance/radius of the coverage radius in all directions centered on each router can be generated, and this can be set as the connection area. Furthermore, the processor 110 can generate the first coverage map by integrating and displaying the connection areas of routers existing within the coordinates of the (indoor/outdoor) drawing data.

At step S203, the processor 110 can receive, from the robot 30, a first RSSI measured by the robot 30 at a first location for managing the communication coverage through the transceiver 120.

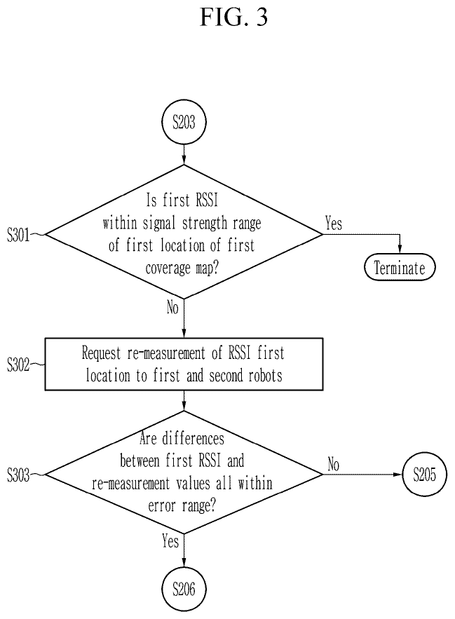

At step S204, the processor 110 can execute the blind area analysis program 132, to determine whether the received first RSSI is a reliable value. Detailed steps of the step S204 will be further described below with reference to FIG. 3.

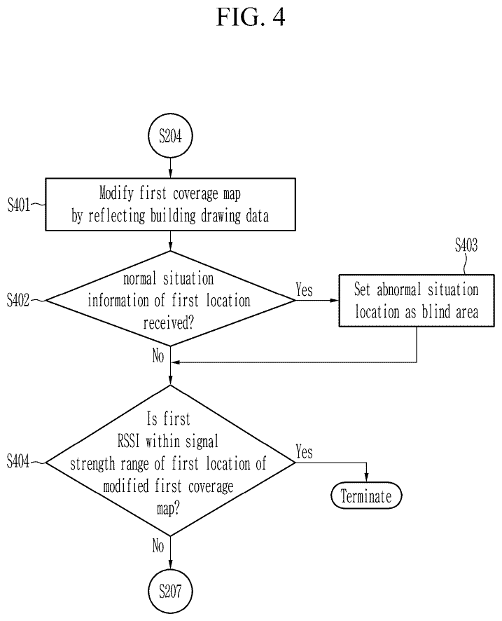

When the processor 110 determines at step S204 that the first RSSI is a reliable value, the processor 110 can determine at step S206 whether the first location is included in the one or more connection areas based on the first RSSI. Detailed steps of the step S206 will be further described below with reference to FIG. 4.

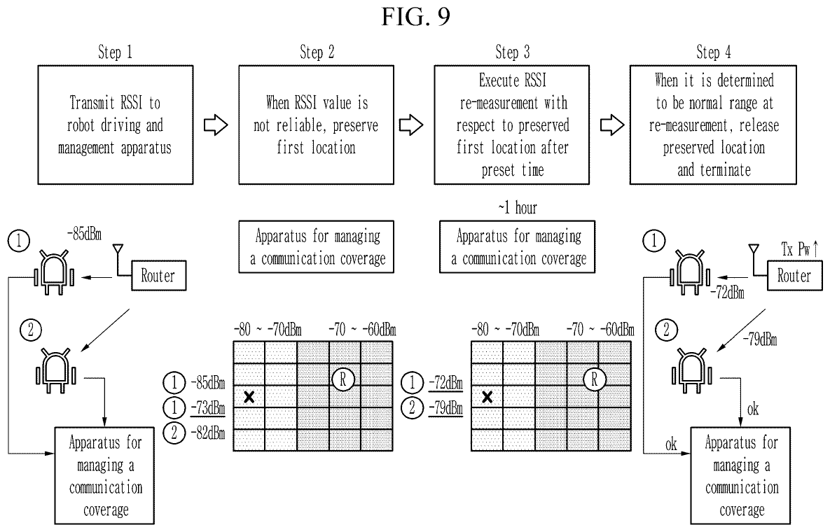

When the processor 110 determines that the first RSSI is not a reliable value at step S204, the processor 110 can mark the first location and store it in the memory 130 at step S205, wait for a preset time, and then transmit a command to measure the RSSI of the first location to the robot 30 again. In an implementation, there can be one or more robots, and the processor 110 can transmit a command to measure the RSSI of the first location to each of the one or more robots through the transceiver 120. As will be described in detail later with reference to FIG. 9, the apparatus 10 for managing the communication coverage can receive a re-measured RSSI of the first location from each of the plurality of robots, and when the first location is determined to be within the connection area based on the re-measured RSSI values, the processor 110 can delete the preserved/stored first location and stop monitoring on the first location.

In some implementations, when it is determined that the first location is not included in the connection area at step S206, at step S207, the processor 110 can set the first location as the blind area and store the first location in the memory 130.

Afterwards, at step S208, the processor 110 can calculate a first threshold value, which is a communication signal strength required for the first location to belong to the connection area, and can calculate a first adjustment value based on a difference between the first threshold value and the first RSSI. The processor 110 can transmit the first adjustment value and a control command to the router 20 through the transceiver 120, to control the router to adjust the transmission power as much as the first adjustment value.

At step S209, after the router 20 has adjusted the transmission power, the processor 110 can re-receive a modified coverage radius information from the router 20 through the transceiver 120. Thereafter, the processor 110 can generate a second coverage map by executing the coverage mapping program 131 based on the modified coverage radius information.

FIG. 3 is a flowchart showing step S204 of FIG. 2 in more detail.

At step S301 of FIG. 3, the processor 110 can determine whether the received first RSSI is within a signal strength range corresponding to the first location of the first coverage map. More specifically, the processor 110 can determine which region among a plurality of regions included in the connection area of the first coverage map the first location corresponds to, and can determine whether the first RSSI is included within the signal strength range corresponding to a first region that is a corresponding region.

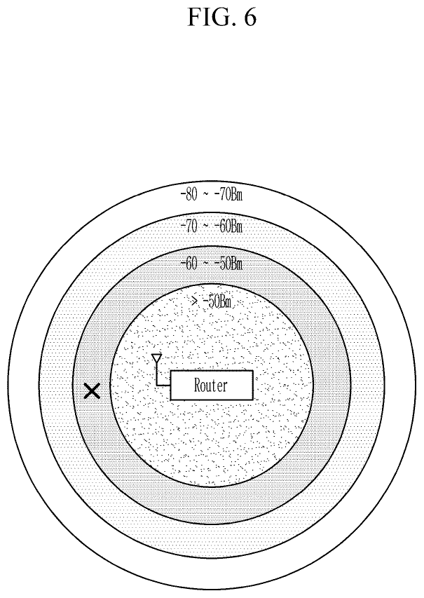

As an example, the processor 110 can determine which region among a plurality of regions included the connection area of the first coverage map shown in FIG. 5 the first location corresponds to. In addition, for example, FIG. 6 illustrates a plurality of detailed signal strength ranges within the first region to which the first location belongs. For example, the corresponding first region can have four sections having a specific signal strength range centered on the router 20. For example, each section can have signal strength ranges of 1) −50 dBm or greater, 2) −60 dBm or greater and less than −50 dBm, 3) −70 dBm or greater and less than −60 dBm and 4) −80 dBm or greater and less than −70 dBm. In some implementations, the connection area can be defined as a region between a location where the communication signal strength is measure at −80 dBm, which can be used as the first threshold value, and the location of the router 20. In other implementations, the connection area can be defined as a region between a location where the communication signal strength is measure at −70 dBm, −60 dBm, −50 dBm, or any other suitable signal strength range (which can be used as the first threshold value), and the location of the router 20.

In some implementations, in FIG. 6, the first location can be marked with a mark X, and accordingly, the first location can correspond to the signal strength range of −60 dBm or greater and less than −50 dBm. However, when the first RSSI measured at the first location was measured to be −85 dBm, as an example, this does not correspond to the signal strength range of −60 dBm or greater and less than −50 dBm, and it can proceed to step S302.

Afterwards, at step S302, the processor 110 can transmit a request to re-measure an RSSI of the first location to a first robot and a second robot among the plurality of robots through the transceiver 120.

At step S303, the processor 110 can receive a second RSSI and a third RSSI, which are the re-measured RSSI values of the first location, from each of the first robot and the second robot through the transceiver 120. For example, when an (allowable) error range is preset to ±5 dBm, when the values of the second RSSI and the third RSSI are −83 dBm and −82 dBm, respectively, as an example, all of them can be within the (allowable) error range based on the first RSSI value of −85 dBm. In this case, the processor 110 can determine the first RSSI to be a reliable value and proceed to the step S206. When the value of the second RSSI and/or the value of the third RSSI is not within the (allowable) error range, the processor 110 can proceed to the step S205.

In some implementations, the present disclosure is not limited to the signal strength range and value described above, and can also be set to the signal strength range and value other than the described range and value.

FIG. 4 is a flowchart showing step S206 of FIG. 2 in more detail.

At step S401, the processor 110 can execute the coverage mapping program 131, to modify the first coverage map based on (building) drawing data. More specifically, the processor 110 can modify the first coverage map based on wall/structure data existing on one coordinate among a plurality of location coordinates representing the location of the first coverage map. When it is determined that the location coordinates where the wall/structure data exists is included in the connection area, the processor 110 can modify the connection area as a region between the location coordinate of the wall/structure data and the location coordinate of the router 20 within the corresponding connection area.

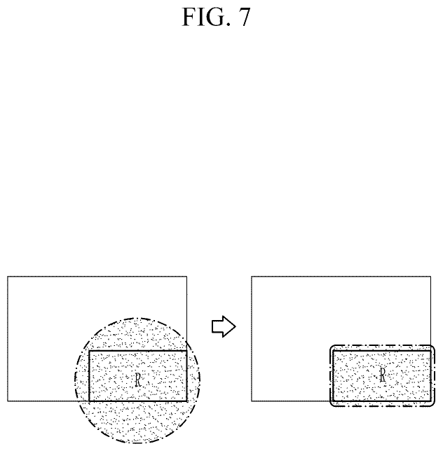

In FIG. 7, an example of the step S401 is illustrated. In the left of the arrow in FIG. 7, the connection area illustrated as a shaded circle having a predetermined radius centered on the router indicated as ‘R’ is shown. Here, walls/structures within the connection area are indicated by a thick solid line, and the processor 110 can determine that a wall/structure exists within a circular range illustrated as the connection area. Therefore, the processor 110 can modify the connection area to be the region between the location coordinates of the wall/structure data and the location coordinate of the router 20 within the corresponding connection area, and as a result, as shown in the right of the arrow in FIG. 7, the connection area can be modified to a form following the shape of the walls/structures (e.g., similar to a rectangular shape in the example of FIG. 7).

In some implementations, at step S402 of FIG. 4, the processor 110 can receive abnormal situation information of the first location from the first robot and/or the second robot. The first robot and/or the second robot can drive in an (indoor/outdoor) region corresponding to the first coverage map, and can check the abnormal situation information of multiple locations through a plurality of sensors mounted on each of the first robot and the second robot. The plurality of sensors can include a visual sensor such as a camera, a distance sensor, a temperature sensor, a humidity sensor, a gas sensor, and/or a voice recognition sensor. The abnormal situation information can be information on physical environment, such as whether a fire has occurred or whether there is a facility construction at a particular location. When the abnormal situation information of the first location is received from the first robot and/or the second robot, the processor 110 can modify the first coverage map by setting the first location as the blind area.

At step S404, the processor 110 can determine whether the first RSSI is included within the signal strength range of the first location of the modified first coverage map again. The step S404 can be formed of the same process as the above-described step S301, and the detailed description will not be included herein. Here, when it is determined that the first RSSI is not included within the signal strength range of the first location of the modified first coverage map, the processor 110 can proceed to the step S207 to perform a subsequent process.

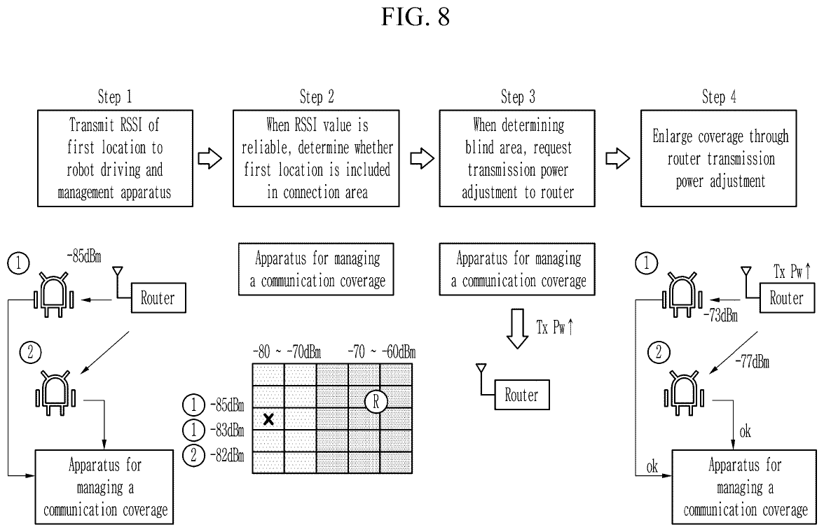

FIG. 8 schematically illustrates an example process of controlling the router, when an RSSI measured by the system 1 for managing the communication coverage of the present disclosure is a reliable value.

At step 1 of FIG. 8, the first robot and the second robot can each drive (indoor/outdoor) regions corresponding to the first coverage map, measure RSSI values with respect to multiple locations, and transmit them to the apparatus 10 for managing the communication coverage. Here, the first RSSI measured with respect to the first location by the first robot can be, for example, −85 dBm.

At step 2, the apparatus 10 for managing the communication coverage can determine that the first RSSI does not belong to the range of −80 dBm or greater and less than −70 dBm, which is the signal strength range corresponding to the region to which the first location belongs, and can transmit a command to measure the RSSI of the first location to each of the first robot and the second robot. As described above in detail with reference to FIG. 3 and FIG. 6, the first RSSI can be determined to be a reliable value, so that the apparatus 10 for managing the communication coverage can determine whether the first location is included within the connection area. In the present example, −85 dBm, which is the value of the first RSSI does not belong to the range of −80 dBm or greater, which is within the signal strength range corresponding to the connection area, and the apparatus 10 for managing the communication coverage can set the first location as the blind area.

At step 3, the apparatus 10 for managing the communication coverage can calculate a transmission power adjustment value required for the first location to belong to the connection area, and can transmit the adjustment value and transmission power adjustment request to the router 20.

At step 4, the first robot and the second robot can measure the RSSI of the first location again after the transmission power of the router has been adjusted, and can transmit it to the apparatus 10 for managing the communication coverage. As an example, when the re-measured RSSI of each of the first robot and the second robot is −73 dBm and −77 dBm, respectively, it is within the range of −80 dBm or greater and less than −70 dBm, which is the signal strength range corresponding to the region to which the first location belongs and, thus, the processor 110 can determine that the blind area of the first location has been removed. As discussed above, aspects of the present disclosure can efficiently manage an indoor/outdoor communication coverage by using the plurality of RSSI received from the one or more robots.

FIG. 9 schematically illustrates an example process of preserving and monitoring the measured location, when an RSSI measured by the system 1 for managing the communication coverage of the present disclosure is not a reliable value.

At step 1 of FIG. 9, the first robot and the second robot can each drive in indoor/outdoor regions corresponding to the first coverage map, measure RSSI values with respect to multiple locations, and transmit them to the apparatus 10 for managing the communication coverage. Here, the first RSSI measured with respect to the first location by the first robot can be, for example, −85 dBm.

At step 2, the apparatus 10 for managing the communication coverage can determine that the first RSSI does not belong to the range of −80 dBm or greater and less than −70 dBm, which is the signal strength range corresponding to the region to which the first location belongs, and can transmit a command to measure the RSSI of the first location to each of the first robot and the second robot. As described above in detail with reference to FIG. 3, the RSSI measured by each of the first robot and the second robot is −73 dBm and −82 dBm, which does not belong to the allowable error range, so that the processor 110 can determine that the first RSSI is not a reliable value. In this case, the apparatus 10 for managing the communication coverage can mark the first location as a monitoring-target location, and can store and preserve it in the memory 130.

At step 3, the apparatus 10 for managing the communication coverage can transmit a request to measure an RSSI with respected to the preserved first location to the first robot and the second robot after a preset time has lapsed. For example, when the re-measured RSSI of each of the first robot and the second robot is −72 dBm and −79 dBm, it belongs to −80 dBm or greater and less than −70 dBm, which is the signal strength range corresponding to the region to which the first location belongs, and the first location can be determined to be within the connection area. In this case, the apparatus 10 for managing the communication coverage can deleted the preserved first location from the memory 130, and can terminate monitoring on the first location.

As described above in the detailed description, according to the method for managing the communication coverage of the present disclosure, an actual blind area can be determined through the RSSI measured from the one or more robots, so that the communication coverage area can be efficiently managed even in the indoor/outdoor environment. In addition, when determining the blind area, whether the RSSI measured by robot is an actually reliable value can be preferentially determined, so that a situation in which modification of the communication coverage map is required can be determined more accurately.

A method according to an implementation can be implemented through a computing device.

The computing device can include at least one of a processor, a memory, a user interface input device, a user interface output device, and storage device that communicate through a bus. The computing device can also include a network interface electrically connected a network. The network interface can transmit or receive signals with other entities through a network. The network interface can be a transceiver that can transmit or receive wired/wireless signals carrying information and/or data, signals, messages, or the like.

The processor can be implemented in various types such as a micro controller unit (MCU), an application processor (AP), a central processing unit (CPU), a graphics processing unit (GPU), a neural processing unit (NPU), or the like, and can be any type of semiconductor device capable of executing instructions stored in the memory or storage device. The processor can be configured to implement the functions and methods described above.

The memory and the storage device can include various types of volatile or non-volatile storage media. For example, the memory can include a read-only memory (ROM) and random-access memory (RAM). In the present implementation, the memory can be located inside or outside the processor, and the memory can be connected to the processor through various known means.

At least some configurations or functions according to an implementation can be implemented as a program or software executable in the computing device, and the program or software can be stored in a computer-readable medium.

At least some configurations or functions according to an implementation can be implemented by using hardware or circuitry of the computing device, or can be implemented as separate hardware or circuitry that can be electrically connected to the computing device.

In some implementations, all of the functions of the system/device/module/unit described herein may be performed by a single processor. In other implementations, the functions of the system/device/module/unit described herein may be distributed among multiple processors (e.g., one processor performs a subset of the functions while one or more other processors perform the remaining functions).

Since the implementations described above are specific implementations for realizing the present disclosure, it should be understood that the present disclosure includes not only the above-described implementations but also implementations that can be simply designed or easily changed by using the above-described implementations. Therefore, the spirit of the present disclosure should not be limited to the implementations described above, and should be defined by the following claims of the present disclosure and their equivalents.

What is claimed is:

1. An apparatus for managing a communication coverage, the apparatus comprising:
a transceiver;
a memory; and
one or more processors in communication with the memory,
wherein the one or more processors are configured to:
receive location and coverage radius information of a router, through the transceiver;
generate a first coverage map corresponding to the location of the router based on the location and coverage radius information of the router;
request a first location representing a location of a first robot and a first Received Signal Strength Indicator (RSSI) that is a first communication signal strength corresponding to the first location of the first robot, wherein the first robot is configured to measure a communication signal strength;
receive the first location and the first RSSI from the first robot, through the transceiver;
determine whether the first RSSI is a reliable value;
determine whether the first location is included within a connection area of the first coverage map based on the first coverage map, the first location, and the first RSSI, based on the first RSSI being a reliable value;
set the first location as a blind area based on a determination that the first location is not included in the connection area;
calculate a first adjustment value based on a difference between the first RSSI and a first threshold value for a second communication signal strength required for the first location to be within the connection area; and
transmit a control request to adjust a transmission power as much as the first adjustment value to the router, through the transceiver.

2. The apparatus of claim 1, wherein the connection area is a region between the location of the router and a location where a communication signal strength transmitted by the router is measured to be the first threshold value.

3. The apparatus of claim 1, wherein the one or more processors are configured to:
determine whether the first RSSI is within a signal strength range corresponding to the first location of the first coverage map;
transmit a measurement request for an RSSI of the first location to the first robot and a second robot, through the transceiver, based on a determination that the first RSSI is not within the signal strength range;
receive a second RSSI that is an RSSI value of the first location measured by the first robot and a third RSSI that is an RSSI value of the first location measured by the second robot, through the transceiver; and
determine the first RSSI as a reliable value based on a determination that (i) a first absolute value obtained by subtracting the second RSSI from the first RSSI is equal to or lower than a first value and (ii) a second absolute value obtained by subtracting the third RSSI from the first RSSI is equal to or lower than a first value.

4. The apparatus of claim 3, wherein the one or more processors are configured to:
determine which region among a plurality of regions included in the connection area of the first coverage map the first location corresponds to; and
determine whether the first RSSI is included in the signal strength range corresponding to a first region to which the first location belongs.

5. The apparatus of claim 2, wherein the one or more processors are configured to:
modify the first coverage map by using drawing data comprising a plurality of location coordinates representing locations of the first coverage map and structure data existing at one or more first coordinates among the plurality of location coordinates;
modify the first coverage map by setting the first location as the blind area, based on receiving abnormal situation information of the first location from the first robot or a second robot, through the transceiver; and
set the first location as the blind area based on a determination that the first RSSI is not included in a signal strength range corresponding to the first location of the modified first coverage map.

6. The apparatus of claim 5, wherein the one or more processors are configured to modify the connection area to be a region between the one or more first coordinates of the structure data and the location of the router based on a determination that one or more first coordinates of the structure data are within the connection area.

7. The apparatus of claim 1, wherein the one or more processors are configured to:
store the first location in the memory based on the first RSSI not being a reliable value; and
transmit a command for re-measuring an RSSI of the first location after a first preset time to the first robot and a second robot.

8. The apparatus of claim 1, wherein the one or more processors are configured to:
receive modified coverage radius information from the router, through the transceiver; and
generate a second coverage map corresponding to the location of the router based on the location of the router and the modified coverage radius information.

9. A method for managing a communication coverage, comprising:
receiving location and coverage radius information of a router, through a transceiver;
generating a first coverage map corresponding to the location of the router based on the location of the router and the coverage radius information;
requesting a first location representing a location of a first robot and a first Received Signal Strength Indicator (RSSI) that is a first communication signal strength corresponding to the first location of the first robot, wherein the first robot is configured to measure a communication signal strength;
receiving the first location and the first RSSI from the first robot, through the transceiver;
determining whether the first RSSI is a reliable value;
determining whether the first location is included within a connection area of the first coverage map based on the first coverage map, the first location, and the first RSSI based on the first RSSI being a reliable value;
setting the first location as a blind area based on a determination that the first location is not included in the connection area;
calculating a first adjustment value based on a difference between the first RSSI a first threshold value for a second communication signal strength required for the first location to be within the connection area; and
transmitting a control request to adjust a transmission power as much as the first adjustment value to the router, through the transceiver.

10. The method of claim 9, wherein the connection area is a region between the location of the router and a location where a communication signal strength transmitted by the router is measured to be the first threshold value.

11. The method of claim 9, wherein the determining whether the first RSSI is a reliable value comprises:
determining whether the first RSSI is within a signal strength range corresponding to the first location of the first coverage map;
transmitting a measurement request for an RSSI of the first location to the first robot and a second robot, through the transceiver based on a determination that the first RSSI is not within the signal strength range;
receiving a second RSSI that is an RSSI value of the first location measured by the first robot and a third RSSI that is an RSSI value of the first location measured by the second robot, through the transceiver; and
determining the first RSSI as a reliable value based on a determination that (i) a first absolute value obtained by subtracting the second RSSI from the first RSSI is equal to or lower than a first value and (ii) a second absolute value obtained by subtracting the third RSSI from the first RSSI is equal to or lower than a first value.

12. The method of claim 11, wherein the determining whether the first RSSI is within the signal strength range corresponding to the first location of the first coverage map comprises:
determining which region among a plurality of regions included in the connection area of the first coverage map the first location corresponds to; and
determining whether the first RSSI is included in the signal strength range corresponding to a first region to which the first location belongs.

13. The method of claim 10, wherein the determining whether the first location is included in the connection area of the first coverage map comprises:
modifying the first coverage map by using drawing data comprising a plurality of location coordinates representing locations of the first coverage map and structure data existing at one or more first coordinates among the plurality of location coordinates;
modifying the first coverage map based on receiving abnormal situation information of the first location from the first robot or a second robot, through the transceiver; and
setting the first location as the blind area based on a determination that the first RSSI is not included in a signal strength range corresponding to the first location of the modified first coverage map.

14. The method of claim 13, wherein the modifying the first coverage map by using the drawing data comprising the structure data comprises:
modifying the connection area to be region between the one or more first coordinates of the structure data and the location of the router based on a determination that one or more first coordinates of the structure data are within the connection area.

15. The method of claim 9, further comprising:
storing the first location in a memory based on the first RSSI not being a reliable value; and
transmitting a command for re-measuring an RSSI of the first location after a first preset time to the first robot and a second robot.

16. The method of claim 9, further comprising:
receiving modified coverage radius information from the router, through the transceiver; and
generating a second coverage map corresponding to the location of the router based on the location of the router and the modified coverage radius information.

17. A non-transitory computer-readable medium storing one or more instructions for managing a communication coverage, wherein the one or more instructions, when executed by one or more processors, cause the one or more processors to perform operations comprising:
receiving location and coverage radius information of a router;
generating a first coverage map corresponding to the location of the router based on the location and coverage radius information of the router;
requesting a first location representing a location of a first robot and a first Received Signal Strength Indicator (RSSI) that is a first communication signal strength corresponding to the first location of the first robot, wherein the first robot is configured to measure a communication signal strength;
receiving the first location and the first RSSI from the first robot;
determining whether the first RSSI is a reliable value;
determining whether the first location is included within a connection area of the first coverage map based on the first coverage map, the first location, and the first RSSI, based on the first RSSI being a reliable value;
setting the first location as a blind area based on a determination that the first location is not included in the connection area;
calculating a first adjustment value based on a difference between the first RSSI and a first threshold value for a second communication signal strength required for the first location to be within the connection area; and
transmitting a control request to adjust a transmission power as much as the first adjustment value to the router.

18. The non-transitory computer readable medium of claim 17, wherein the determining whether the first RSSI is a reliable value comprises:
determining whether the first RSSI is within a signal strength range corresponding to the first location of the first coverage map;
transmitting a measurement request for an RSSI of the first location to the first robot and a second robot based on a determination that the first RSSI is not within the signal strength range;
receiving a second RSSI that is an RSSI value of the first location measured by the first robot and a third RSSI that is an RSSI value of the first location measured by the second robot; and
determining the first RSSI as a reliable value based on a determination that (i) a first absolute value obtained by subtracting the second RSSI from the first RSSI is equal to or lower than a first value and (ii) a second absolute value obtained by subtracting the third RSSI from the first RSSI is equal to or lower than a first value.

19. The non-transitory computer readable medium of claim 18, wherein the determining whether the first RSSI is within the signal strength range corresponding to the first location of the first coverage map comprises:
determining which region among a plurality of regions included in the connection area of the first coverage map the first location corresponds to; and
determining whether the first RSSI is included in the signal strength range corresponding to a first region to which the first location belongs.

20. The non-transitory computer readable medium of claim 17, wherein the connection area is a region between the location of the router and a location where a communication signal strength transmitted by the router is measured to be the first threshold value,
wherein the determining whether the first location is included in the connection area of the first coverage map comprises:
modifying the first coverage map by using drawing data comprising a plurality of location coordinates representing locations of the first coverage map and structure data existing at one or more first coordinates among the plurality of location coordinates;
modifying the first coverage map based on receiving abnormal situation information of the first location from the first robot or a second robot; and
setting the first location as the blind area based on a determination that the first RSSI is not included in a signal strength range corresponding to the first location of the modified first coverage map.
